(19) United States
(12) Patent Application Publication
(10) Pub. No.: US 2021/0197036 A1
(43) Pub. Date: Jul. 1, 2021

(54) GOLF CLUB HEAD

(71) Applicants: Romain Louis Billiet, Penang (MY); Hanh Thi Nguyen, Penang (MY)

(72) Inventors: Romain Louis Billiet, Penang (MY); Hanh Thi Nguyen, Penang (MY)

(21) Appl. No.: 16/729,503

(22) Filed: Dec. 30, 2019

(51) Int. Cl. A63B 53/04; B29C 45/00

(52) U.S. Cl. CPC A63B 53/0466; B29K 2009/06; A63B 2053/0416; B29C 45/0001

(57) ABSTRACT

A golf club head with center of gravity proximate to the club head's sweet spot is disclosed. The golf head is composed of a strike face component made from a high-density material and a club body component made from a lightweight material. This combination improves the golfer's chances to strike the golf ball with the club head sweet spot and to land the ball closer to the hole on the green.

### CROSS-REFERENCE TO RELATED APPLICATIONS

Not Applicable

### REFERENCES CITED

U.S. Patent Documents

| | | | |
|---|---|---|---|
| 4,883,274 | November 1989 | Hsien | 273/164 |
| 5,518,235 | May 1996 | Mendenhall | 473/314 |
| 6,733,703 B2 | May 2004 | Billiet et al. | 264/40.1 |
| 7,758,451 B2 | July 2010 | Liang et al. | 473/334 |
| 7,803,065 B2 | September 2010 | Breier et al. | 473/334 |
| 7,819,757 B2 | October 2010 | Soracco et al. | 473/332 |
| 7,922,604 B2 | April 2011 | Roach et al. | 473/350 |
| 8,938,871 B2 | January 2015 | Roach et al. | A63B 53/0466 |
| 9,220,959 B2 | December 2015 | Roach et al. | A63B 53/047 |
| 9,649,541 B2 | May 2017 | Soracco | A63B 53/0466 |
| 2004 0157679 A1 | August 2004 | Poincenot et al. | 473/324 |
| 2008 0051215 A1 | February 2008 | Rae et al. | 473/345 |
| 2016 0151861 A1 | June 2016 | Soracco et al. | B23K 26/342 |
| 2018 0253774 A1 | September 2018 | Soracco et al. | G06Q 30/0621 |
| D711,993 S | August 2014 | Miraflor, III et al. | D21/759 |

### Foreign Patent Documents

### OTHER PUBLICATIONS

### Non-Patent Literature

Anonymous: “The physics of billiards” (https://www seal-world-physics-problems.com/physics-of-billiards.html)
Anonymous: “Hole in one” (https://en.wikipedia.org/wiki/Hole_in_one)
Anonymous: “Coefficient of Restitution” (https://en.wikipedia.org/wiki/Coefficient_of_restitution)
Kelley, Brent: “What Is Coefficient of Restitution (COR) in Golf Clubs?” (https://www.liveabout.com/what-is-cor-1563310)
Covey, Tony: “How Golf Club Center of Gravity Makes a Huge Difference”, My Golf Spy, May 13, 2015, (https://mygolfspy.com/golf-club-center-of-gravity-cg/)
Grober, Robert: “The Physics of Golf”, Youtube.com
Anonymous: “The Sweet Spot: What Is It and Where Do I Find It?”, (http://www.golfloopy.com/sweet-spot/)
Arnold, Douglas, Dr.: “Mathematics that Swings: The Math Behind Golf”, Youtube.com
Sheid, Francis, Ph.D. “You're Not Getting Enough Strokes”, Golf Digest, June 1975, reprinted in “The Best of Golf Digest, 1950-1975, The First 25 Years” pp. 32-33, Simon & Schuster, ISBN-10: 0914-178-075
McKinney, Rick: “Driver's Center of Gravity”, Center of Gravity in your Driver, (www.golfclub-technology.com)
Anonymous: “Two-component Metal Injection Molding (2C-MIM) (https://www.ifam.fraunhofer.de/en/Profile/Locations/Bremen/Shaping_Functional_Materials/Powder_Technology/Metal_Injection_Molding_MIM/2C-MIM.html)

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND

### Field of the Invention

The present invention relates to golf heads including woods, irons, putters and, more particularly, to golf drivers.

### Description of Prior Art

In the game of golf, it is the dream of every golfer to score a “hole-in-one”, also known as an “ace”, where a player hits the ball from the teeing ground into the hole on the green with a single stroke.

Occasionally special hole-in-one tournaments are hosted, where prizes as expensive as a new car, or cash awards sometimes reaching $4 million are offered to the contestant who records a hole-in-one.

Yet, the odds for scoring a hole in one are high. Boston University mathematician Francis Scheid, Ph.D., on behalf of Golf Digest magazine determined these odds at approximately 12,000 to 1 for the average golfer.

It is a prevailing sentiment in the golf world that a prerequisite to such extraordinary shots is for the golfer to strike the ball with the club's so-called “Sweet Spot”

Golf equipment manufacturers shrewdly exploit the golfer's psychological urge to achieve this coveted feat by advertising golf clubs claimed to possess design features that will increase the size of the Sweet Spot and thereby the golfer's chances to hit the ball with it. Yet none of these manufacturers provide a clear, unambiguous definition of this mirage-like entity.

For example, in Hsien, U.S. Pat. No. 4,883,274, Col. 1, lines 60-61: “Face-centered sweet spots give a wider sweet spot impact area”

In Breier et al. U.S. Pat. No. 7,803,065, Abstract, lines 7-8: “[ . . . ] weight inserts to enhance the playing characteristics” and Col. 6, lines 16-18: “[ . . . ] expanding the size of the club head “sweet spot” [ . . . ]”

In Soracco et al. U.S. Pat. No. 7,819,757 Col. 6, lines 55-56: “Moving or rearranging mass to the club perimeter enlarges the sweet spot and produces a more forgiving club.”

In Roach et al. U.S. Pat. No. 7,922,604, Col. 2, lines 39-40: “[ . . . ] to increase the size of the club head, and expand the sweet spot.”

In Breier et al. U.S. Pat. No. 7,938,740, Co1.3, lines 48-49: “[ . . . ] increasing the size of the striking face increases the sweet spot [ . . . ]

Some authors discredit the importance of the Sweet Spot altogether, emphasizing instead the club head's center of gravity (CG) as the primary factor for optimizing the golfer's shot. For example, in the article “The Sweet. Spot: What is it and Where Do I Find It?” given in reference, the author states:

“The sweet spot of any golf club is a point on the club face that is no bigger than the sharp end of a pin. Nothing that equipment manufacturers do can ever make it bigger. [ . . . ] The reason that this spot is “sweet” is that, when the CoG (Center of Gravity) of the club head is moving directly towards the CoG of the golf ball at impact, this provides the optimal energy transfer from the club head to the ball.”

Despite its loose definition in the golf literature, the tag “Sweet Spot” has caught on and is likely to remain in popular use, if only because a golfer can unmistakably feel when his/her golf club head strikes the ball with it.

### BRIEF SUMMARY OF THE INVENTION

According to the present invention, there is provided a method to fabricate an improved golf club head.

The golf club head of the instant invention is composed of two separate body members. A first body member comprises the club head's striking face, rim and hosel, while a second body member comprises the club body proper.

The first body member is produced from a high-density material while the second body member is produced from a low-density material.

The two body members are joined by prior art techniques.

In a particular embodiment of the instant invention, when the two body members are both produced from weldable metallic alloys, they may be joined by the technique of sinter bonding, as will be described in more detail below.

Final positioning of the club head's center of gravity is done by adjusting the position of the center of gravity of the first body member.

### OBJECTS AND ADVANTAGES

It is an object of the present invention to provide a golf club which, at the instant of club/ball impact, has a high probability of striking the ball with the club's sweet spot.

It is also an object of the instant invention to provide a golf club which does not require the addition of discrete weights to arbitrarily shift the location of the club's center of gravity.

It is a further object of the instant invention is to provide a method to fabricate a golf club head with improved functionality over prior art golf club heads.

Still a further object of the present invention is to provide a method to fabricate a golf club head more economically by reducing or eliminating prior art machining operations and the inevitably associated generation of machining scrap.

Yet another object of the present invention is to provide a method to fabricate a golf club head without the need for welding the club head body to the strike plate.

Finally, it is highly desirable to provide a method for making a golf club incorporating all of the above desirable features.

The instant invention fulfills all these desiderata.

### BRIEF DESCRIPTION OF THE SEVERAL VIEWS OF THE DRAWINGS

FIG. 1 is a sketch illustrating the principle of the instant invention. It shows a cross section of the two separate components of the golf club and the location of their respective centers of gravity prior to their assembly.

FIG. 2 is a graph showing the effect of missing the Sweet Spot on the golf ball landing point on the Green

FIG. 3 is a sketch showing the effect of moving the club head center of gravity (CG1) closer to the golf ball surface.

FIG. 4 shows the first golf head component comprising the striking face with surrounding rim and hosel.

FIG. 5 shows the second golf head component comprising the roof, sole and toe.

FIG. 6 shows the assembly of the two components of the golf club head

### DETAILED DESCRIPTION OF THE INVENTION

Following definitions will be used in the present Disclosure:

HOLE: The hole on the golf course green where the golf ball is expected to end its trajectory.

PATH: The straight line from the golf ball's center of gravity (CG2) on the Tee to the Hole

TRAJECTORY: The path followed by the golf ball upon being struck by the club head.

DIRECTION OF MOTION (DM): The horizontal component of the Trajectory.

SWEET SPOT: The intersection of the line joining the club head's center of gravity (CG1) and the golf ball's center of gravity (CG2) with the club's striking face.

While the location of CG1 is a fixed property of the club head which can be shifted by adding or subtracting discrete masses to the club, as is routinely done in practices such as perimeter weighting, the position of the golf ball's center of gravity (CG2) depends on the ball diameter, the height of the tee, the particular location of the ball, i.e. on the fairway, in short grass, in the rough, in a sand bunker, water hazard or out-of-bounds.

The present invention posits that by reducing the distance between the golf club's center of gravity (CG1) and the golf ball's center of gravity (CG2) at the moment of impact, the golfer's chances to hit the ball with the golf club's sweet spot are increased and, as a corollary, his/her chances to land the ball closer to the Hole.

This situation is analogous to allowing novice riflemen or archers on a shooting range to shoot from closer to the target to improve their accuracy and boost their confidence.

In this Disclosure, the dynamics of golf club/ball impact are modeled after the physics of billiard ball collisions where a ball is also struck with the objective of landing it in a hole.

Three real life situations are examined.

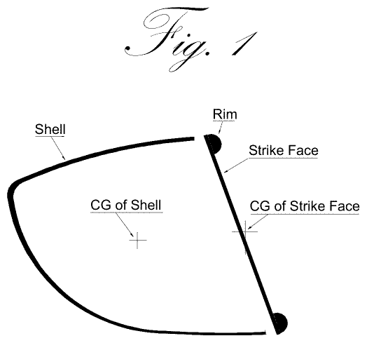

Referring now to FIG. 1, a golf ball is struck with the Direction of Motion (DM) either in line with or at an angle with the Path. The deviation e is the amount by which the golfer “misses” the Sweet Spot.

CASE 1: The Direction of Motion (DM) of the club head's center of gravity coincides with the Path.

In this situation, the angle α between the Direction of Motion (DM) and the Path is zero. The ball is effectively struck with the club head's Sweet Spot, thereby transferring optimal energy from the club to the ball. The ball flies straight in the direction of the Hole. This is the ideal situation and neither the golfer nor any modification to the golf club can improve on it.

CASE 2: The Direction of Motion (DM) diverges from the Path

In this more common situation, the angle α between the Direction of Motion (DM) and the Path is not zero. There are two sub-possibilities:

CASE 2.1: The Direction of Motion (DM) passes through the ball's center of gravity (CG2).
In this case, the ball is still struck with the club head's Sweet Spot. However, the ball flies off in a direction forming an angle α with the Path. This is the same situation as in Case 1 but rotated by angle α. The only way the golfer can remediate this situation is by working on his/her swing, not through any modification to the golf club.

CASE 2.2: The Direction of Motion (DM) does not pass through the ball's center of gravity (CG2).
This is the most common situation in real life. In this case, the angle α between The Direction of Motion (DM) and the Path may be very small, but it is not zero. The ball is not struck with the club head's Sweet Spot. The ball will not fly in the desired direction and will acquire a rotational component, resulting in a so-called fade or draw. The golfer can remediate this situation by working on his/her swing and also, as will be shown in this Disclosure, through a design modification to his golf club in accordance with the instant invention.

Still referring to FIG. 1, for any e>0, the Direction of Motion (DM) of the golf ball will form an angle α with the Path. The magnitude of α is given by

α=arcsin(2e/44) where d is the golf ball diameter

Under the rules of golf, a golf ball has a diameter not less than 1.680 inch (42.671 mm). In this example, the golf ball diameter will arbitrarily be taken as d=44 mm, therefore

α=arcsin(2e/44) which, for e=5 mm yields

α=arcsin(2*5 mm/44 mm)≈13.13 degrees

Let F be the distance from the Tee to the Hole (the Drive).

The average longest drive in golf is 300 yards or 274,320 mm, therefore

E/e=F/OA=274,320 mm/OA

cos α=OA/d/2=OA/22, from which

OA=22*cos α=21.424 mm

E/e=274,320 mm/21.424 mm≈12,804 hence

E=12,804*e (E and e in mm) or (1)

E=14*e (E in yards, e in mm)

which, with e =5 mm yields

E=70 yards

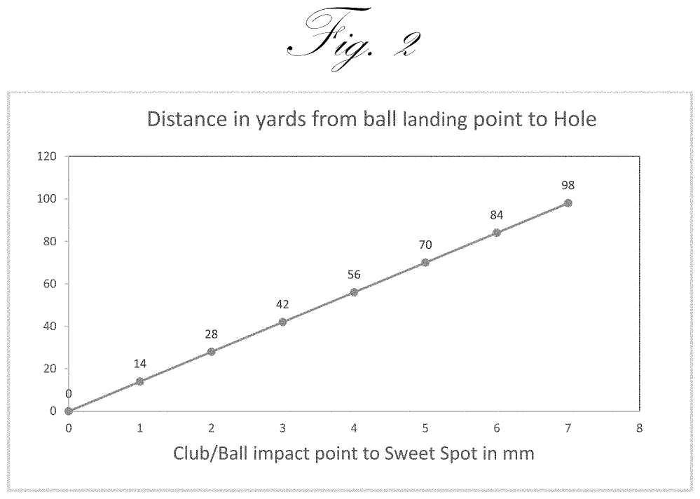

FIG. 2 shows the distance from ball landing point to Hole as a function of the deviation e of the club/ball impact point from the Sweet Spot.

The average area of a green in Canada and the US is 5,000 square feet or 464.5152 square meters. Assuming, as is often the case, that the green is circular, its radius R will be given by

R=√(464.5152 m²/2π)=4,299 mm=4.7 yards

Thus, in order for the golf ball to land on a circular green and neglecting any other factors affecting ball flight such as loft, ball velocity vector, wind, air density and turbulence, terrain, etc., E has to be less than 4.7 yards.

For example, for E=4 yards or 3,657.6 mm, eq. (1) yields:

e=3,657.6 mm/12,804≈0.285 mm

This is roughly equivalent to the diameter of 3 human hairs, a tall order even for the best of the best.

Next, the effect of the location of golf club Center of Gravity (CG1) is examined.

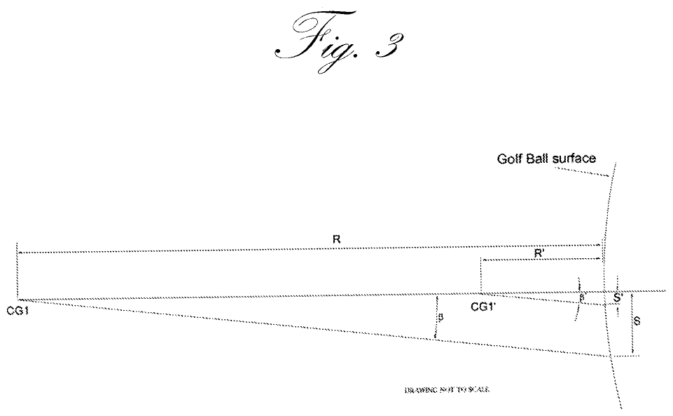

Referring now to FIG. 3, as an example, let R, the distance from the club CG1 to the Sweet Spot on the club striking face be 1.5 inch (38.1 mm)

At the instant of club/ball impact and in the earlier example where e=5 mm, we have a rectangular triangle with hypotenuse R=38.1 mm and short side of the right angle S=5 mm, i.e. the amount by which the golfer misses the Sweet Spot.

In this example, the Direction of Motion (DM) of the club's center of gravity (CG1) and the line between CG1 and the ball's center of gravity (CG2) form an angle β such that:

β=arcsin(S/R)=arcsin(5 mm/38.1 mm)=7.54 degrees.

Under identical conditions of swing, i.e. with the same angle β of 7.54 degrees, when the golf club's center of gravity (CG1) is moved closer to the Sweet Spot, say to CG1′ and if R′ is the new distance from CG1′ to the point of impact and S′ is the new deviation from the sweet spot, triangle similarity yields:

S/R=S′/R′ or S′=R′S/R

For example, with R′=4 mm, S′=4 mm*5 mm/38.1 mm=0.525 mm

Substituting into equation (1) yields:

E=12,804*0.525 mm=6,721 mm≈7.35 yards

In summary, by simply moving CG1 proximate to the Sweet Spot, the distance between the ball's landing point and the Hole has gone from 70 yards to about 7 yards, a significant improvement!

The prior art does not appear to have taken advantage of this important benefit to the golfer, presumably because

1. it is impractical to move the center of gravity of a three dimensional body in close proximity to—and impossible to move onto—one of its external surfaces, and

2. the addition of discrete masses to the striking face would adversely affect its springiness and thereby the club's Coefficient of Restitution (COR)

The instant invention overcomes these problems by using an innovative approach.

The golf club head of the instant invention is composed of two separate body constituents.

A first body constituent, herein termed Strike Face, comprises the club head's striking face, a rim surrounding its outside perimeter, and the hosel for attaching the club head to the shaft and grip.

The rim serves the express purpose of moving the center of gravity of the Strike Face forward, i.e. proximate to, onto, or even in front of the club's Sweet Spot.

A second body constituent, herein called Shell, comprises the club body proper.

The two body constituents are preferably fabricated by plastic, metal (MIM) or ceramic injection molding (CIM) technology, thus obviating costly machining operations.

The Strike Face is preferably injection molded to net-shape from a high-density material such as SCb291, a niobium-tantalum-tungsten alloy with density 9.57 g/cm³; TZM, a titanium-zirconium alloy with density 10.31 g/cm³; WC-10Co, a tungsten carbide alloy with 10% cobalt and density 15.88 g/cm³; or THA, a tungsten heavy alloy with density 18.5 g/cm³.

The second body constituent is preferably injection molded from a low-density material, such as an aluminum-lithium alloy with density in the 2.1-2.7 g/cm³ range; graphene, with density 2.267 g/cm³; carbon fiber with density 1.57-1.70 g/cm³; silicone rubber with density 1.1-2.3 g/cm³; acrylonitrile butadiene styrene (ABS) with density 1.060-1.080 g/cm³; polyurethane (PUR) with density 0.096 g/cm³, or various combinations thereof.

The two body constituents are joined by prior art techniques.

In one specific embodiment of the instant invention, when the two body constituents are both produced from weldable metallic alloys, they may be joined by co-sintering them while at least one is in the green state, i.e. substantially devoid of organic matter, in an operation commonly referred to as sinter bonding or 2C-MIM. Clearly, it is essential in such case that the shrinkage factors upon sintering of the two materials be matched, as taught by Billiet et al. U.S. Pat. No. 6,733,703.

Sinter bonding or 2C-MIM can also be used when one of the two body constituents is a metallic alloy and the other one a ceramic, but in that case, the ceramic body member is usually pre-sintered because of its higher sintering temperature.

In contrast with prior art practice where the center of gravity of the golf club is arbitrarily—and subjectively—shifted by the addition of discrete masses in operations such as perimeter weighting, in the instant invention, the location of the club's center of gravity is entirely and precisely controlled during the component design stage.

The manufacturing process of golf clubs in accordance with the instant invention will now be described in detail.

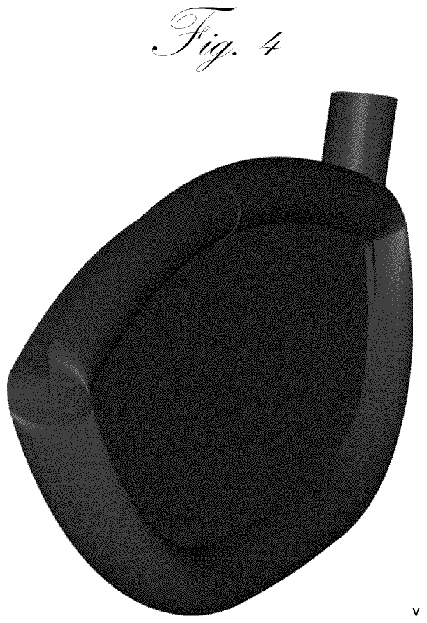

Referring to FIG. 4, the first golf club head component or Strike Face, comprising its surrounding rim and hosel, is advantageously designed using modern 3D CAD software such as DesignCAD™ marketed by IMSI Design, Novato, Calif. This precludes the need to fabricate a prototype while allowing for precise positioning of the center of gravity in the desired location during the design stage.

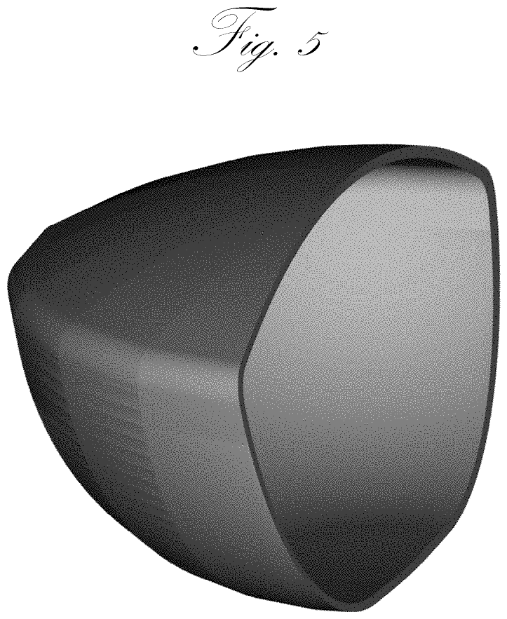

Referring now to FIG. 5, the second golf club head component or Shell, is likewise advantageously designed using 3D CAD software.

The 3D CAD drawings, together with the appropriate shrinkage factor for the respective materials, are now used to fabricate injection molding tools in view of the production of green parts.

The final step in the design stage is the precise location and, if desired, the relocation of the center of gravity of the assembly.

Depending on the materials selected for the two club component members, they can be processed jointly or separately as explained above.

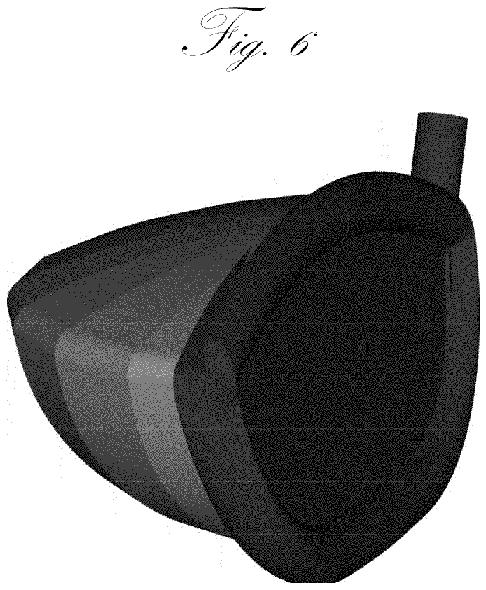

FIG. 6 shows the assembly of the two component members into the golf club head.

DesignCAD™ software yields the component's volume and the Cartesian coordinates of their center of gravity. In the instant invention, only the x-coordinate is of relevance as it is the one in the Direction of Motion (DM).

Assuming both component members are made from the same material, say 17-4PH stainless steel with density 7.8 g/cm³, as is often the case in the prior art, and using the examples given above, we find:

| FIG. | Designation | Volume | x-coordinate | Mass |
|---|---|---|---|---|
| 4 | Strike Face | 24,968.51 mm³ | −0.030 cm | 194.75 g |
| 5 | Shell | 7,868.95 mm³ | −2.963 cm | 61.37 g |
| 6 | Club | 32,837.46 mm³ | −2.764 cm | 256.13 g |

It is clear from these figures that the assembly of the two golf head body components has only resulted in moving the center of gravity of the assembled golf club head slightly forward, i.e. in the direction of Motion (DM), with reference to the location of the center of gravity of the Shell.

However, in the instant invention, the golf club Strike Face is made from Tungsten Heavy Alloy (THA) and the Shell from acrylonitrile butadiene styrene (ABS), yielding:

| FIG. | Designation | Volume, mm³ | Material | Density | Mass, g |
|---|---|---|---|---|---|
| 4 | Strike Face | 24,968.51 | THA | 18.5 g/cm³ | 461.917 |
| 5 | Shell | 7,868.95 | ABS | 1.06 g/cm³ | 8.341 |

DesignCAD™ software is unable to calculate the x-coordinate of the club's center of gravity due to the difference in density between club components. Consequently, a Lever-type Rule is applied, as follows:

By definition, the center of gravity of an object is the point where all the moments of force of all the constituents are balanced. Therefore, if X is the x-coordinate of the club's center of gravity, and the distance between the centers of gravity of the Strike Face and the Shell is

−2.963 cm+(−0.030 cm)=−2.993 cm, we obtain:

8.341 g*(−2.993 cm−X)=461.341 g*X from which

X=−0.053 cm

In summary, by switching the materials for the fabrication of the golf club components from 17-4PH stainless steel to Tungsten Heavy Alloy (THA) for the Strike Face and acrylonitrile butadiene styrene (ABS) for the Shell, the x-coordinate of the center of gravity of the assembled golf club has been moved from −27.64 mm to −0.53 mm which, as was shown above, significantly improves the golfer's chances of landing the ball close to the Hole on the green.

### Conclusion, Ramifications And Scope

In conclusion, the major advantage of this invention resides in the ability to economically produce to net-shape, i.e. without machining, a golf club head which integrates precisely controlled design features that increase the golfer's chances to reduce his/her handicap and to hit a hole-in-one.

Although the invention has been described with respect to specific preferred embodiments thereof, many variations and modifications will immediately become apparent to those skilled in the art, e.g. through the use of different component designs, or the use of different materials, or molding feedstock compositions formulated to yield precise predetermined densities upon sintering.

The practical uses of the present invention are clearly broad in scope and universal in application and attempting to enumerate them all would not materially contribute to the description of this invention.

It is therefore the intention that the appended claims be interpreted as broadly as possible in view of the prior art to include all such variations and modifications.

We claim as our invention:

1. A method for producing a golf club head having its center of mass proximate to said club head's sweet spot, comprising the steps of:
a. fabricating a first golf club body member having a face intended to strike a golf ball, a rim lining the outside perimeter of said face and a hosel for attaching a golf club shaft and grip,
b. fabricating a second golf club body member having a sole, crown and toe,
c. assembling said first and second body members to form said golf club head.

2. The method as set forth in claim 1 wherein said first golf club body member is preferably injection molded from a high-density material such as SCb291, a niobium-tantalum-tungsten alloy with density 9.57 g/cm³; TZM, a titanium-zirconium alloy with density 10.31 g/cm³; WC-10Co, a tungsten carbide alloy with 10% cobalt and density 15.88 g/cm³; or THA, a tungsten heavy alloy with density 18.5 g/cm³.

3. The method as set forth in claim 1 wherein said second golf club body member is preferably injection molded from a low-density material such as an aluminum-lithium alloy with density in the 2.1-2.7 g/cm³ range; graphene, with density 2.267 g/cm³; carbon fiber with density 1.57-1.70 g/cm³; silicone rubber with density 1.1-2.3 g/cm³; acrylonitrile butadiene styrene (ABS) with density 1.060 -1.080 g/cm³; polyurethane (PUR) with density 0.096 g/cm³ or various combinations thereof.

4. The method as set forth in claim 1 wherein said first golf club body member is joined to said second golf club body member by sinter bonding or 2C-MIM technology.

5. The method as set forth in claim 1 wherein said first and second golf club body members are produced to net shape without the need for machining and thus avoiding the associated generation of machining scrap.

6. The method as set forth in claim 1 wherein said golf club body is produced without the need for welding.

7. The method as set forth in claim 1 wherein the location or relocation of said club's center of gravity does not require the addition or removal of weights.

8. The method as set forth in claim 1 wherein said location of said club's center of gravity is done during the design stage.
